(19) United States
(12) Patent Application Publication
(10) Pub. No.: US 2010/0171054 A1
(43) Pub. Date: Jul. 8, 2010

(54) MICROMECHANICAL SLOW ACTING VALVE SYSTEM

(75) Inventor: Lars STENMARK, Trosa (SE)

Correspondence Address: FOLEY AND LARDNER LLP;SUITE 500, 3000 K STREET NW, WASHINGTON, DC, 20007, US

(73) Assignee: ASTC AEROSPACE AB, Uppsala (SE)

(21) Appl. No.: 12/516,097

(22) PCT Filed: Nov. 28, 2007
(86) PCT No.: PCT/SE2007/050912

§ 371 Date: Jan. 12, 2010

(30) Foreign Application Priority Data
Nov. 28, 2006 (SE) 0602523-3

(51) Int. Cl. F16K 31/165

(52) U.S. Cl. 251/61.1

(57) ABSTRACT

The present invention provides an integrated microvalve system (1) comprising at least a first fluid branch (8) and a microvalve (2) being controlled by a control pressure in a control channel (17). The microvalve (2) is adapted to control a fluid flow in the first fluid branch (8). A flow restrictor arrangement (21) is located between a control port (19) and the control channel (17) to give a pre-determined turn-on and turn-off response characteristics of the microvalve (2). Preferably the flow restrictor arrangement (21) comprises a deflate channel (30) and an inflate channel (31) arranged in parallel. Each channel (30, 31) comprises a check valve (34, 35) and a flow restrictor (24, 25), which may have different flow restriction to give different turn-on and turn-off response characteristics for the microvalve (2).

### TECHNICAL FIELD OF THE INVENTION

The present invention relates to miniaturised valve systems, and in particular to integrated valve systems, which commonly are fabricated using silicon micromachining.

### BACKGROUND OF THE INVENTION

Microsystems technology (MST) or microelectromechanical systems (MEMS) can be regarded as a spin-off from the microelectronics. In miniaturised systems from this technology field, integrated circuits may be combined with e.g. mechanical, fluid, chemical, or biological systems in an integrated system. Commonly the choice of design, materials and processing is made on the basis of the vast knowledge from microelectronic processing, but as the field of MEMS has developed and found new application areas the technology have been acknowledged as a stand-alone technology and the development of design and processing is rapidly improving.

One important application area of MEMS is microfluidics. Microfluidics deals with the behavior, precise control and manipulation of small volumes of fluids. By using MEMS-technologies highly miniaturised fluidic system can be accomplished. The complexity of such systems may be very high and virtually any functionality can be incorporated. Microfluidics is mostly used for development of biotechnical systems such as e.g. lab-on-a-chip devices or bioassays, but other application areas begin to benefit from the superior properties of microfluidics. One important application area is micropropulsion, which may be used in for example space technology for e.g. altitude control. By using microfluidic MEMS-structures the overall size and mass of e.g. a propulsion system becomes drastically decreased and consequently the size and mass of a satellite to be launched becomes substantially reduced. Moreover the reliability of an integrated micropropulsion system is potentially higher than for a conventional system.

As in microelectronics the microfluidic MEMS-structures are mainly fabricated using silicon wafers as substrates, but e.g. other semiconducting materials, polymers, ceramics and glass are emerging.

Valves in fluidic systems usually have fast response times to properly control flow rates in the system. In fluidic systems that handles high pressures and high flow rates such valves may cause detrimental pressure gradients or shockwaves. This is a problem for conventional valves and in particular for miniaturised valves due to their inherently fast response times.

In many fluidic systems it is desirable to have parallel fluid branches, each controlled by at least one valve having an individual turn-on and turn-off response time. One such fluidic system is found in bi-propellant rocket engines, wherein the control of the turn-on and turn-off of different fluid branches is very important. Another application may be in chemical analysis, wherein a plurality of reactants is to be added in a pre-determined sequence. Conventionally a single valve, controlled by e.g. an electrical motor or a linear actuating device, is used to obtain the above described feature. The linear acting device may be a pneumatic or a hydraulic device. However, such conventional valve control devices are relatively heavy and bulky.

### SUMMARY OF THE INVENTION

Obviously the prior art has drawbacks with regards to being able to provide valve system having small size and weight and permitting high flow rates and a pre-determined response time.

The object of the present invention is to overcome the drawbacks of the prior art. This is achieved by the device as defined in the independent claim.

In a first aspect the present invention provides an integrated microvalve system comprising at least a first fluid branch and a microvalve being controlled by a control pressure in a control channel. The microvalve is adapted to control a fluid flow in the first fluid branch. A flow restrictor arrangement is located between a control port and the control channel to give a pre-determined turn-on and turn-off response characteristics of the microvalve. Preferably, the flow restrictor arrangement comprises at least a first flow restrictor.

In one embodiment the flow restrictor arrangement comprises a deflate channel and an inflate channel arranged in parallel, and of which at least one of the inflate/deflate channel comprises a check valve adjacent to the control port. The first flow restrictor is integrated in the deflate channel, and a second flow restrictor is integrated in the inflate channel. Preferably, the deflate channel comprises a turn-on check valve adjacent to the control port and the inflate channel comprises a turn-off check valve adjacent to the control port. The flow restrictors may have different flow restriction to give different turn-on and turn-off response characteristics for the microvalve.

The integrated microvalve system may comprises two or more parallel fluid branches, wherein the microvalve/microvalves of each fluid branch is connected to a separate flow restrictor arrangement, preferably adapted to give different turn-on and turn-off response characteristic for said two or more parallel fluid branches.

In a second aspect the present invention provides an integrated microvalve system comprising a pressure controlled microvalve, which comprises at least a first flexible membrane acting against a first valve seat. The maximum deflection of the flexible membrane is preferably limited and the flexible membrane is further preferably provided with damping means.

Thanks to the invention it is possible to provide an integrated microvalve system having a high pressure capability and a controlled response time.

It is a further advantage of the invention to provide an integrated microvalve system that has a large cross-sectional flow area permitting a high flow rate in one or several parallel branches. The microvalve system may comprise several parallel fluid branches, each having different pre-defined response times.

It is yet a further advantage of the invention to provide an integrated microvalve system with low power consumption.

It is yet another advantage of the invention to provide a microvalve that comprises a protection for catastrophic failure due to exposure to high pressure.

Embodiments of the invention are defined in the dependent claims. Other objects, advantages and novel features of the invention will become apparent from the following detailed description of the invention when considered in conjunction with the accompanying drawings and claims.

### BRIEF DESCRIPTION OF THE DRAWINGS

Preferred embodiments of the invention will now be described with reference to the accompanying drawings, wherein

FIG. 1 is a schematic block diagram of an integrated microvalve system comprising a flow restrictor arrangement according to the present invention,

FIG. 2a is a schematic block diagram of an integrated microvalve system comprising two flow restrictors and one check valve integrated in the deflate channel according to the present invention,

FIG. 2b is a schematic block diagram of an integrated microvalve system comprising two flow restrictors and one check valve integrated in the inflate channel according to the present invention,

FIG. 3a is a schematic block diagram of an integrated microvalve system comprising a flow restrictor arrangement according to the present invention,

FIG. 3b is a schematic block diagram of an integrated microvalve system comprising two parallel fluid branches according to the present invention,

FIG. 4a-c are schematic diagrams illustrating the relative microvalve position of a) the first fluid branch, b) the second fluid branch and c) the control pressure in the control port of an integrated microvalve system according to the present invention,

FIG. 5a-b illustrate cross sectional views of a microvalve in a) closed and b) open position according to the present invention,

FIG. 6 is a cross-sectional view of a dual membrane microvalve according to the present invention,

FIG. 7a-b illustrate cross sectional views of a gas suspension means of a microvalve according to the present invention.

### DETAILED DESCRIPTION OF EMBODIMENTS

The basis of the present invention is control of the turn-on and/or turn-off response times of at least one microvalve in an integrated microvalve system. The integrated microvalve system is preferably designed and manufactured using methods, materials and technologies of the field of Microsystem Technology (MST) or Microelectromechanical Systems (MEMS).

Commonly microsystems for fluidics are built using silicon micromachining, which may comprise shaping, typically using photolithography and etching, and bonding of silicon wafers. The present invention is however not limited to silicon micromachining. By way of example other semiconductor materials, polymers and ceramics may be used. Neither is the present invention limited to systems built using photolithography and etching, for example may high precision machining, laser machining, injection moulding, etc. be used. Micromachined wafers may be joined using other methods than bonding, such as welding, soldering, gluing, etc.

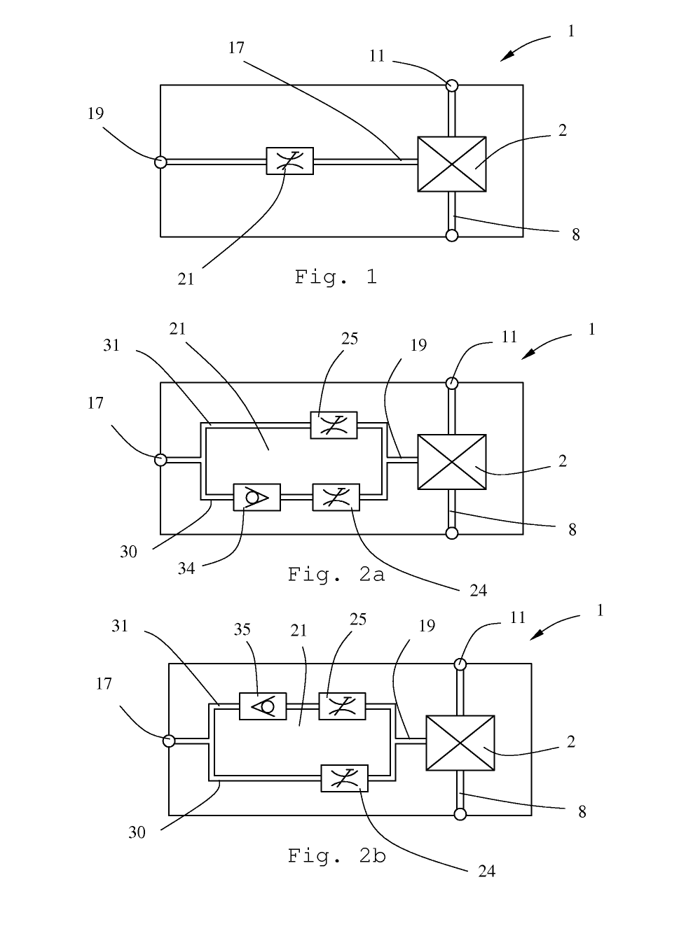

Referring to FIG. 1, one embodiment of the present invention is an integrated microvalve system 1 that comprises a microvalve 2 arranged to control the fluid flow of a fluid branch 8. The microvalve 2 is controlled by a control pressure in a control channel 17 of the integrated microvalve system 1. A flow restrictor arrangement 21 is located between a control port 19 and the control channel 17 to give a pre-determined turn-on and turn-off response characteristics of the microvalve 2.

In one embodiment of the present invention the flow restrictor arrangement 21 comprises at least a first flow restrictor 24.

Referring to FIGS. 2a-b, one embodiment of the present invention is an integrated microvalve system 1 comprising a microvalve 2 arranged to control the fluid flow of a fluid branch 8. The microvalve 2 is controlled by a control pressure in a control channel 17 of the integrated microvalve system 1. A flow restrictor arrangement 21 is located between a control port 19 and the control channel 17 to give a pre-determined turn-on and turn-off response characteristics of the microvalve 2. The flow restrictor arrangement 21 comprises a deflate channel 30 and an inflate channel 31 arranged in parallel. A first flow restrictor 24 is integrated in the deflate channel 30, and a second flow restrictor 25 is integrated in the inflate channel 31. At least one channel 30, 31 comprises a check valve 34, 35 adjacent to the control port 19. The check valves may be located either in the deflate channel 30, as illustrated in FIG. 2a, or in the inflate channel 31, as illustrated in FIG. 2b.

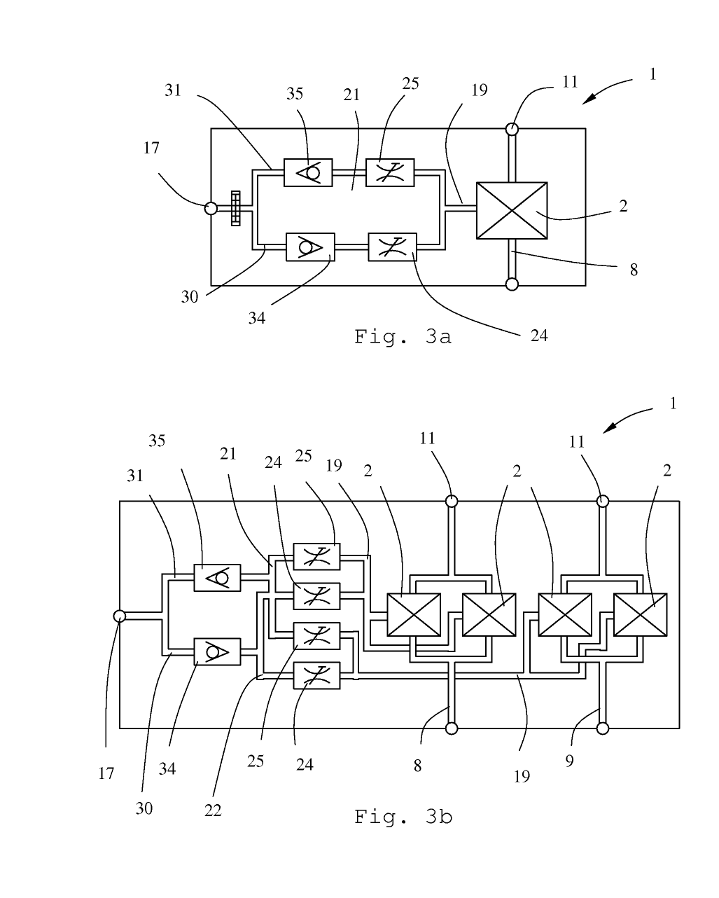

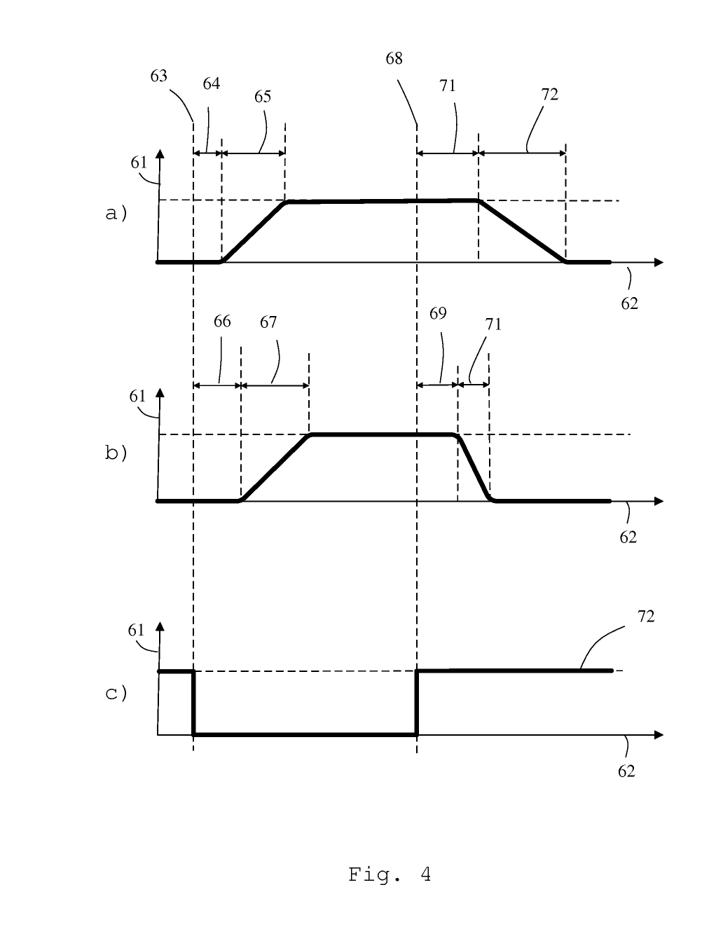

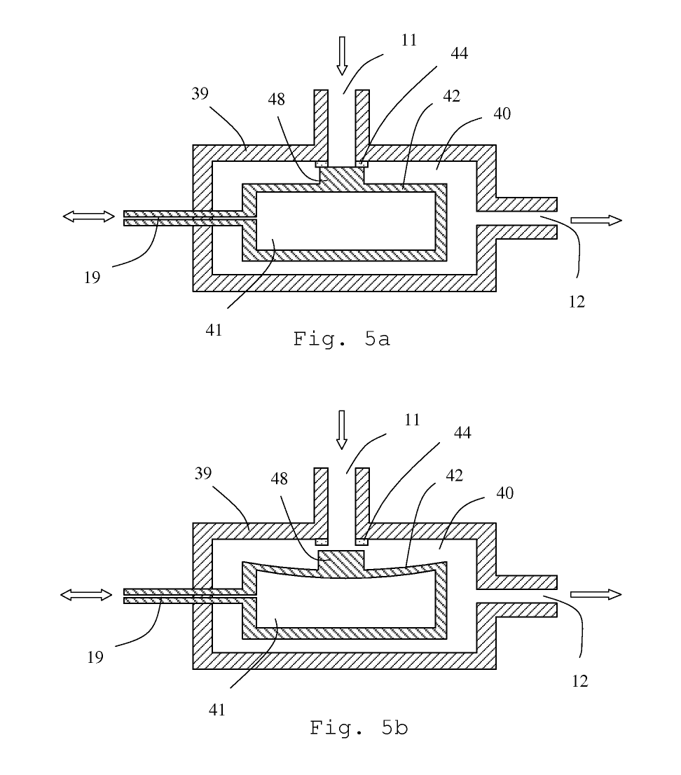

Referring to FIG. 3a one embodiment of the present invention is an integrated microvalve system 1 comprising a microvalve 2 arranged to control the fluid flow of a fluid branch 8. The microvalve 2 is controlled by a control pressure in a control channel 17 of the integrated microvalve system 1. A flow restrictor arrangement 21 is located between a control port 19 and the control channel 17 to give a pre-determined turn-on and turn-off response characteristics of the microvalve 2. The flow restrictor arrangement 21 comprises a deflate channel 30 and an inflate channel 31 arranged in parallel. A first flow restrictor 24 and a turn-on check valve 34 are integrated in series in the deflate channel 30, and a second flow restrictor 25 and a turn-off check valve 35 are integrated in series in the inflate channel 31. The check valves 34, 35 are preferably located between the control port 19 and the flow restrictors 24, 25.

The microvalve 2 of the fluid branch 8 is controlled by a pressure difference between an inlet pressure in an inlet 11 of the fluid branch 8 and a control pressure in the control channel 17. In principle, the microvalve 2 is closed if the pressure difference between the inlet pressure in the inlet 11 and the control pressure in the control channel 17 is less than a critical pressure difference and open when the pressure difference is exceeding the critical pressure difference. However, unlike conventional pressure controlled microvalves 2 the response times of the microvalve 2 of the present invention are given by the flow restrictor arrangement 21.

One example of the operation of the integrated microvalve system 1 of FIG. 3a is given in the following. The microvalve 2 is pressure controlled and normally closed when the pressure in the control channel 17 is higher or equal to the pressure at the fluid inlet 11. In steady state the pressure in the control channel 17 is equal to the pressure in the control port 19. If the pressure at the control port 19 decreases significantly from the steady state level gas start flowing from the inflated volume inside the microvalve 2 through the first flow restrictor 24 and the turn-on check valve 34. At a certain pressure drop the microvalve 2 slowly opens until a position where the fluid flow is maximal. When the pressure at control port 19 is raised to a turn-off level the turn-on check valve 34 is closed and the turn-off check valve 35 opens, permitting gas to slowly pass the second flow restrictor 25 into the deflated volume of the microvalve 2, where the gas flow slowly increases the pressure and inflates the volume. At a certain pressure the microvalve 2 start to close again until it is fully closed. The response time for open and closing is determined mainly by the flow restrictors 24, 25. It should be noted that the requirements on the check valves 34, 35 are quite low with respect to leakage. A small leakage in one or both check valves 34, 35 only acts as a small decrease of the opposite flow restriction.

The flow restrictors 24, 25 may be formed by conventional micromachining. By way of example the flow restrictors 24, 25 may comprise e.g. crossed grooves of adjacent silicon wafers.

One embodiment of the present invention comprises a filter 28, which protects the check valves 34, 35 from particle contamination. The flow restriction provided by the filter 28 adds flow restriction to the flow restriction caused by the flow restrictor arrangement 21.

Referring to FIG. 3b, one embodiment of an integrated microvalve system according to the present invention comprises two or more parallel fluid branches 8, 9. Each fluid branch 8, 9 is connected to separate flow restrictor arrangement 21, 22. The flow restrictor arrangements 21, 22 may have different pre-determined turn-on and/or turn-off response characteristics for the different fluid branches. Preferably, however not limited to this, the fluid branches 8, 9 have common turn-on and turn-off check valves 34, 35.

One embodiment of an integrated microvalve system 1 according to the present invention comprises two or more parallel fluid branches 8, 9. Each fluid branch 8, 9 is connected to separate flow restrictor arrangement 21, 22, each comprising a deflate channel 30 and an inflate channel 31 arranged in parallel. Each deflate channel 30 comprise at least a first flow restrictor 24 and each inflate channel 31 comprises at least a second flow restrictor 25. The flow restrictor arrangements 21, 22 have independent pre-determined turn-on and/or turn-off response characteristics for the different fluid branches 8, 9 due to different flow restriction of the first and second flow restrictors 24, 25 of the different flow restrictor arrangements 21, 22. Preferably, however not limited to this, the fluid branches 8, 9 have common turn-on and turn-off check valves 34, 35 and a common control port 19. Further a filter 28 may be arranged at the control port 19 to protect the turn-on and turn-off check valves 34, 35 from particle contamination.

In one embodiment of an integrated microvalve system according to the present invention each fluid branch 8, 9 comprises two or more microvalves 2 arranged in parallel and connected to a common flow restrictor arrangement 21, 22.

The fluid branches 8, 9 of an integrated microvalve system 1 according to the present invention may be totally separated and can have significant different flow rate capacity.

FIGS. 4a-c schematically illustrate the turn-on/turn-off sequence of an integrated valve system 1 comprising two parallel fluid branches 8, 9, each comprising at least one microvalve 2. A microvalve 2 position 61 of a first fluid branch 8 versus time 62 and a microvalve 2 position 61 of a second fluid branch 9 are illustrated in FIG. 4a and FIG. 4b, respectively. The microvalve position 61 second fluid branch 9 is “0” for a closed microvalve 2 and “1” for a fully open microvalve 2. FIG. 4c illustrates the control pressure 73 at the control port 19. The “on” command is given at a common turn-on time 63. After a first turn-on response time 64 the first fluid branch 8 starts to open slowly, and after a second turn-on response time 66 also the second fluid branch 9 starts to open. The first fluid branch is fully open after a first opening time 65 and the second fluid branch is fully open after a second opening time 67. At a common turn-off time 68 an “off” command is given later and the turn-off sequence starts. After a turn-off response time 69 the microvalve of the first fluid branch 8 the microvalve 2 of the first fluid branch 8 starts to close. The microvalve 2 of the second fluid branch is fully closed after a second closing time 70. After a turn-off response time 71 the microvalve of the second fluid branch 9 the microvalve 2 of the second fluid branch 9 starts to close. The microvalve 2 of the second fluid branch is fully closed after a second closing time 72.

Referring to FIGS. 5a-b, one embodiment of an integrated microvalve system according to the present invention comprises a pressure controlled microvalve 2 arranged between an inlet 11 and an outlet 12. The microvalve 2 comprises a fluid cavity 40 in a valve body 39 having an inlet 11 and an outlet 12. Depending on application, the inlet 11 may be functional as an outlet and vice versa. The inlet 11 is assumed to be the fluid inlet in the following text. The opposite gives different response on the control pressure, but the basic function is the same. The microvalve 2 further comprises at least a first flexible membrane 42 arranged on a control cavity 41, which is located inside the fluid cavity 40 and connected to a control channel 17. The first flexible membrane 42 is acting against a first valve seat 44 at the inlet 11. An increase of the pressure inside the control cavity yields an outward deflection of the first flexible membrane, i.e. closing the microvalve 2. The control channel 17 extends through the valve body 39 surrounding the fluid cavity 40. When the pressure in the control cavity 41 is high enough the first flexible membrane 42 is pressed against the valve seat 44 blocking of the fluid inlet 11, as illustrated in FIG. 5a. When the pressure in the control cavity 41 decreases below a given value the first flexible membrane 42 starts to bend inwards opening up the valve, as illustrated in FIG. 5b. The gap between the valve seat 44 and the first flexible membrane 42 depends on the relation between the fluid pressure which acts externally on the first flexible membrane 42 and the control pressure in the control cavity 41 inside the fluid cavity 40.

When the microvalve 2 is closed the fluid pressure in the fluid cavity 40 is low and the contact pressure acting on the valve seat 44 depends on the relation between inlet channel area at the valve seat 44 multiplied with the fluid pressure at the inlet 11 and the area of the flexible membrane 42 multiplied with the control pressure together with the pretension of the flexible membrane 11 on the valve seat. As long as the first force is smaller the second force the sum of pretension and membrane internal pressure times the membrane area the valve is closed.

In another embodiment also a second flexible membrane 43 is located on the opposite wall of the control cavity 41. The second flexile membrane 43 is acting against a second valve seat 45, which preferably is connected to the same inlet 11 as the first valve seat 44.

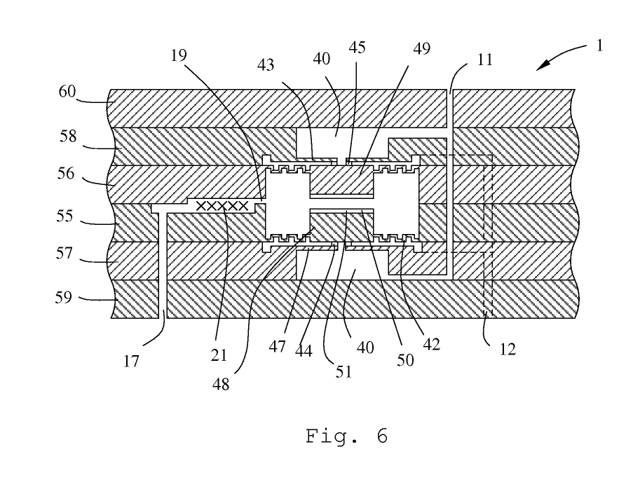

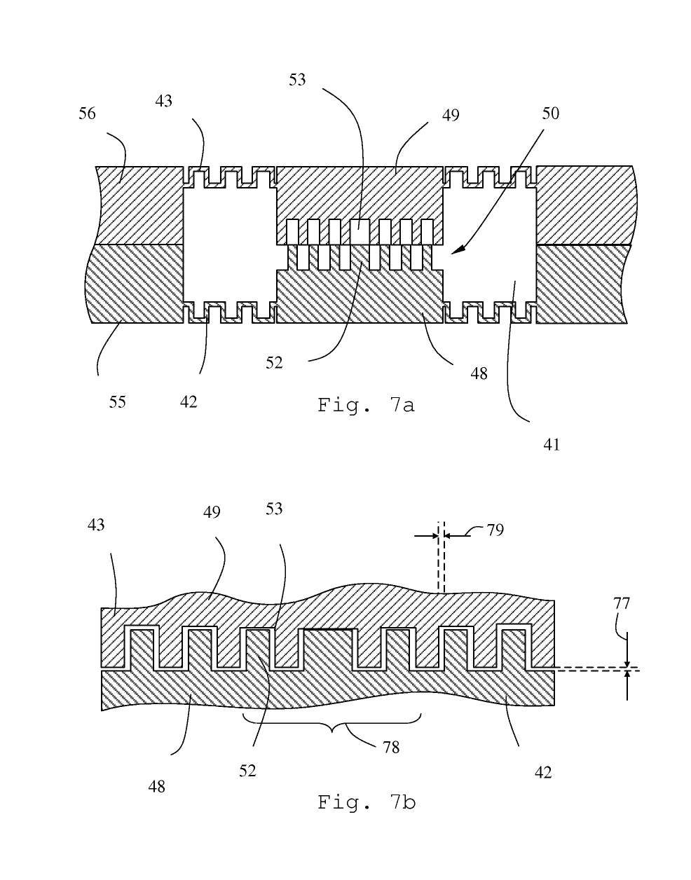

FIG. 6 is a cross sectional view of a microvalve 2 according to the present invention comprising also a second flexible membrane 43 located on the opposite wall of the control cavity 41. The integrated microvalve system 1 is by way of example accommodated in a stack 54 of six micromachined silicon wafers 55. The pressure sensitive control cavity 41 is enclosed in the interface between a first and a second wafer 55, 56. The control cavity 41 comprises a first and a second membrane 11, 12, which may be corrugated, in the first and second wafer 55, 56, respectively. The control port 19 is connected to the control cavity 41 through a flow restrictor arrangement 21. The flow restrictor arrangement may comprise a filter 28 as well.

Each flexible membrane may have a central embossment 48, 49. The flat outer surfaces of the embossments 48, 49 act against the first and the second valve seat 44, 45, respectively. From the fluid inlet 11 the fluid is distributed to two fluid cavities 40 located adjacent each valve seat 44, 45. The cavities 40 and the valve seats 44, 45 are formed in a third and fourth silicon wafer 57, 58. Optionally, a valve seat membrane 47 suspends the valve seat 44, 45 giving some flexibility to prevent wear and tension of the valve seat 44, 45. A fifth silicon wafer 59 comprises the input 11 and a sixth silicon wafer 60 comprises an outlet 12 of the microvalve 2.

The sixth wafer 60 may comprise a control port 19, which is connected to the control cavity 41, and preferably a flow restrictor arrangement 21 according to the present invention is arranged in between the control port 19 and the control cavity 41. The flow restrictor arrangement 21 may be located in any of the silicon wafers 55, 56,57, 58, 59, for example in the interface between the first and the second silicon wafer 55, 56 as shown in FIG. 6.

When the control pressure is decreased the control cavity 41 deflates and both flexible membranes 42, 43 deflect inwards and the microvalve 2 opens. The fluid outlet through both valve seats 44, 45 is collected to a common outlet 12. When the outlet pressure builds up or if the control pressure is further reduced the gap between the embossments becomes zero and the microvalve 2 is open to its maximum. One or both flexible membranes 42, 43 may comprise an anti-stiction means 51, such as an anti-stiction coating, a surface modification and a microstructured surface, to prevent sticking when in contact with each other.

A potential problem with the design of a pressure controlled microvalve is the risk for an avalanche effect when the microvalve 2 opens. When the microvalve 2 opens and fluid starts to flow through the microvalve 2, the outlet pressure will increase as soon as the fluid reaches the next flow restriction down the line. This means that the pressure in the fluid cavity 40 rapidly increases, which will further deflate the control cavity 41 yielding an inward deflection of the flexible membranes 42, 43. In order to prevent a harmful shock when the first and second flexible membranes 48, 49 meets the flexible membranes may comprise damping means 50, e.g. a thick and soft anti-stiction coating located on the embossments 48, 49, which acts as a cushion when the flexible membranes hits each other.

Referring to FIGS. 7a-b, in another embodiment of the present invention the damping means 50 comprises a gas suspension integrated into the system. By way of example, a first and a second wafers 55, 56 forms a pressure sensitive control cavity 41 with flexible membranes 42, 43 and embossments 48, 49 as presented before, but instead for removing wafer material from embossments 48, 49 evenly to create two flat embossments with a certain separation is the wafer material is removed partially on both embossments. In the first embossment 48 protrusions 52, such as pits or grooves, are formed. In the second embossment 49 wafer material is left to form recesses 53, such as posts or ridges, which more or less exactly fits into corresponding protrusions 52 in the first embossment 48. The control cavity 41 is still filled with gas when the membranes are pressed together due to an external pressure. Virtually all gas trapped in the recesses 53 must be squeezed out when the two embossments 48, 49 are meeting each other. Recesses in the form of concentrically grooves is an efficient structure as all gas from smaller diameter traps must pass the larger diameter traps. Posts or segments may permit escape paths from the inner parts and thus lowering the suspension effect.

In a damping means 50 as described above it is important that both etch depths in the embossments 48, 49 are equal in order to minimize the dead volume when the structure is closed. Both the vertical clearance 78 between the two embossments 48, 49 outside the contact area 78 and the lateral clearance 79 between the protrusions 52 and the recesses 53 should be kept to a minimum. By making the central grooves a little narrower the primary contact point automatically can be located to the center, as a groove with higher aspect ratio is etched a little slower than a wider groove. It shall be noted the etch depths of the embossments 48, 49 must be twice what required for flat milled embossments for a given stroke length.

While the invention has been described in connection with what is presently considered to be the most practical and preferred embodiments, it is to be understood that the invention is not to be limited to the disclosed embodiments, on the contrary, is intended to cover various modifications and equivalent arrangements within the appended claims.

1. An integrated microvalve system comprising at least a first fluid branch and a microvalve being controlled by a control pressure in a control channel, the microvalve is adapted to control a fluid flow in the first fluid branch, wherein a flow restrictor arrangement is located between a control port and the control channel to give a pre-determined turn-on and turn-off response characteristics of the microvalve.

2. An integrated microvalve system according to claim 1, wherein the flow restrictor arrangement comprises a first flow restrictor.

3. An integrated microvalve system according to claim 2, wherein the flow restrictor arrangement comprises a deflate channel and an inflate channel arranged in parallel, and of which at least one channel comprises a check valve adjacent to the control port, the first flow restrictor being integrated in the deflate channel, and a second flow restrictor being integrated in the inflate channel.

4. An integrated microvalve system according to claim 3, wherein the deflate channel comprises a turn-on check valve adjacent to the control port.

5. An integrated microvalve system according to claim 3, wherein the inflate channel comprises a turn-off check valve adjacent to the control port.

6. An integrated microvalve system according to claim 3, wherein the flow restrictors have different flow restriction to give different turn-on and turn-off response characteristics for the microvalve.

7. An integrated microvalve system according to claim 1, wherein the first fluid branch comprises two or more microvalves arranged in parallel and connected to an inlet of the first fluid branch.

8. An integrated microvalve system according to claim 7, wherein the microvalves are connected to the flow restrictor arrangement.

9. An integrated microvalve system according to claim 1, wherein the integrated microvalve system comprises two or more parallel fluid branches and the microvalve of each fluid branch is connected to a separate flow restrictor arrangement.

10. An integrated microvalve system according to claim 9, wherein at least two of said two or more parallel fluid branches share turn-on and turn-off check valves.

11. An integrated microvalve system according to claim 9, wherein the flow restrictor arrangements of said two or more parallel fluid branches are adapted to give different turn-on and turn-off response characteristic for said two or more parallel fluid branches.

12. An integrated microvalve system according to claim 1, wherein the microvalve comprises a control cavity connected to the control channel, and at least a first flexible membrane acting against a first valve seat.

13. An integrated microvalve system according to claim 12, wherein a deflection of the first flexible membrane is limited by the valve seat and an opposite sidewall of the control cavity.

14. An integrated microvalve system according to claim 12, wherein the microvalve comprises a second flexible membrane acting against a second valve seat.

15. An integrated microvalve system according to claim 14, wherein a deflection of the first flexible membrane is limited by the first valve seat and the second flexible membrane.

16. An integrated microvalve system according to claim 14, wherein the first valve seat is suspended on a flexible valve seat membrane.

17. An integrated microvalve system according to claim 14, wherein the first flexible membrane comprises a first embossment; the second flexible membrane comprises a second embossment; the first and the second embossments are opposite each other; and at least the first embossment is provided with a damping means within the control cavity.

18. An integrated microvalve system according to claim 17, wherein at least one of the embossments comprises an anti-stiction means selected from the group of an anti-stiction coating, a surface modification and a microstructured surface.

19. An integrated microvalve system according to claim 17, wherein the damping means comprises a protrusion of the first embossment and a thereto fitting recess of the second embossment to form a squeezed film when pressed together.

20. An integrated microvalve system according to claim 1, wherein the integrated microvalve system comprises a stack of micromachined silicon wafers.

21. An integrated microvalve system according to claim 20, wherein the stack of micromachined silicon wafers comprises at least two or more silicon wafers which are bonded together.
